(19) United States
(12) Patent Application Publication
(10) Pub. No.: US 2026/0154214 A1
(43) Pub. Date: Jun. 4, 2026

(54) APPARATUS AND METHOD FOR PROCESSING DATA UNITS

(71) Applicant: Robert Bosch GmbH, Stuttgart (DE)

(72) Inventors: Filip Moerman, Tourrettes Sur Loup (FR); Herbert Leuwer, Langballig (DE); Mourad Ahdjoudj, Antibes (FR); Thomas Wollenhaupt, Backnang (DE)

(21) Appl. No.: 18/683,128

(22) PCT Filed: Oct. 19, 2022
(86) PCT No.: PCT/EP2022/079001

§ 371 Date: Feb. 12, 2024

(30) Foreign Application Priority Data
Oct. 21, 2021 (DE) 10 2021 211 905.0

(51) Int. Cl. G06F 13/20

(52) U.S. Cl. CPC G06F 13/20; G06F 2213/36

(57) ABSTRACT

A hardware-based apparatus, for processing data units, comprising a first number of input interfaces for receiving data units and a second number of output interfaces for outputting data units, and a hardware-based processing device, which is designed to process data units of at least one, e.g., several, of the following layers of the ISO/OSI reference model: layer 2, layer 3, layer 4, layer 5, layer 6.

### FIELD

The present invention relates to an apparatus for processing data units.

The present invention also relates to a method for processing data units.

### SUMMARY

Exemplary embodiments of the present invention relate to an apparatus, e.g., a hardware-based apparatus, for processing data units, comprising a first number of input interfaces for receiving data units and a second number of output interfaces for outputting data units, and a hardware-based processing device, which is designed to process data units of at least one of the following layers of the ISO/OSI reference model: layer 2, layer 3, layer 4, layer 5, layer 6.

In further exemplary embodiments of the present invention, the processing device is designed to process data units of several different layers of the ISO/OSI reference model, for example one after the other and/or with an at least partial overlap in time. In further exemplary embodiments of the present invention, the data units may, for example, be data frames and/or protocol data units and/or data packets or portions thereof or the like.

In further exemplary embodiments of the present invention, it is provided that the apparatus comprises a data storage device for at least temporarily storing data associated with data units of layers 2 and/or 3 and/or 4 and/or 5 and/or 6 of the ISO/OSI reference model, wherein the data storage device can, for example, at least temporarily be jointly used by several components of the apparatus. In further exemplary embodiments, this can at least temporarily result in statistical multiplexing gains.

In further exemplary embodiments of the present invention, it is provided that the apparatus comprises a classifier device for classifying data units of layers 2 and/or 3 and/or 4 and/or 5 and/or 6 of the ISO/OSI reference model.

In further exemplary embodiments of the present invention, it is provided that the apparatus comprises a service quality control device for performing at least one function related to a service quality, e.g., Quality of Service, comprising, for example, at least one of the following elements: a) policing function, b) scheduling function, c) shaping function, wherein the service quality control device is, for example, designed to perform functions related to a service quality, e.g., Quality of Service, for data units of different layers, e.g., of layers 2 and/or 3 and/or 4 and/or 5 and/or 6, of the ISO/OSI reference model.

In further exemplary embodiments of the present invention, it is provided that the apparatus comprises a security device for performing at least one function related to a security, e.g., Security, wherein the security-related function is, for example, associated with a, for example linked, access control list (e.g., chained access control list), wherein one and the same TCAM (ternary content addressable memory) instance can, for example, be used in different layers.

In further exemplary embodiments of the present invention, several, e.g., two, TCAM instances can, for example, be provided, e.g., a first TCAM instance “L2_TCAM,” for example for data units of layer 2, and, for example, a second TCAM instance “L34_TCAM,” for example for data units of layers 3, 4 (and, optionally, for example, also for layer 5).

In further exemplary embodiments of the present invention, the first TCAM instance “L2_TCAM” may, for example, provide three values “value1,” “value2,” “value3” on the basis of a key value “key,” for example according to: L2_TCAM: value1, value2, value3=f (key), wherein the key value “key,” for example, characterizes a target address, e.g., an Ethernet destination (e.g., MAC address), wherein the first valuea “value1,” for example, characterizes output interfaces (e.g., “ports”), for example in the form of a list to which the relevant data unit is to be transmitted, wherein the second value “value2,” e.g., “L2_TCAM_ID,” for example, indexes an entry of the first TCAM instance, which entry results in a match, and wherein the third value “value3,” for example, characterizes a connection identifier, e.g., “connection ID,” for example for identifying layer 2 (“L2”) streams (e.g., data streams), for example for per-stream filtering and/or per-stream policing, i.e., for example, for filtering and/or polishing on the basis of a respective data stream (“stream”), and/or for seamless redundancy.

In further exemplary embodiments of the present invention, the second TCAM instance “L34_TCAM” may, for example, provide one or more values on the basis of a corresponding key value for the second TCAM instance. For example, in further exemplary embodiments, the key value for the second TCAM instance may comprise at least one of the following aspects: a) L1/2 port (interface, e.g., with respect to layer 1 (“L1”) and/or layer 2 (“L2”), b) L2_TCAM_ID, obtained, for example, by the first TCAM instance (e.g., L2), c) IP (internet protocol) header (L3), d) UDP/TCP header (L4).

In further exemplary embodiments of the present invention, by linking, for example, data of both TCAM instances, e.g., data of the second TCAM instance with data of the first TCAM instance, e.g., with the L2_TCAM_ID, a deep packet classification (“deep classification of a packet or a data unit”), e.g., via layers 1 (“L1”) to 4 (“L4”) can, for example, be performed, which classification, for example, provides as values: a) information about drop/pass (e.g., discarding or processing, for example of the relevant data unit), b) layer 4 (“L4”) IP socket identifiers, c) various, for example for special forwarding rules.

In further exemplary embodiments of the present invention, a use of the TCAM component(s) or instance(s) in layer 5 (“L5”) is also possible. This is, for example, possible in further exemplary embodiments in that the TCAM instance(s) can also process data units that are not or not only associated with layers 2 to 4 (L2 . . . L4), but also data units associated with layers 5 and/or 6 (L5/6).

In further exemplary embodiments of the present invention, it is provided that at least one component of the apparatus can be configured, e.g., configured at a runtime or operating time of the apparatus.

In further exemplary embodiments of the present invention, it is provided that at least some, e.g., all, components of the apparatus are arranged on a, e.g., one and the same, semiconductor substrate.

In further exemplary embodiments of the present invention, it is provided that the apparatus is designed as a, for example monolithic, hardware component. In further exemplary embodiments, data units, for example also of higher layers of the ISO/OSI reference model, e.g., of layer 5 and/or layer 6, can thus be processed in hardware (i.e., for example, by the apparatus designed as a hardware component), which enables efficient processing and high data throughput or throughput of data units.

In further exemplary embodiments of the present invention, it is provided that the apparatus is designed to function at least temporarily as a communication gateway.

In further exemplary embodiments of the present invention, it is provided that the apparatus is designed to, at least temporarily, simultaneously process a) data units of layers 2 and/or 3 and/or 4 and/or 5 and/or 6 of the ISO/OSI reference model and/or b) of different protocols.

In further exemplary embodiments of the present invention, it is provided that the apparatus has a throughput of greater than 10 gigabits per second, Gbps, e.g., greater than 20 Gbps.

In further exemplary embodiments of the present invention, it is provided that the apparatus is designed to process data units at an event rate, e.g., Event Rate, of 10 million events per second, e.g., 10 Mevents/sec, e.g., at an event rate of up to 20 million events per second, e.g., 20 Mevents/sec.

In further exemplary embodiments of the present invention, it is provided that the apparatus comprises an input modifier designed to at least temporarily modify at least one incoming data unit and/or at least one descriptor associated with the at least one incoming data unit. In further exemplary embodiments, modifications made by means of the input modifier become “visible” (“common modification”) at the respective output interfaces, for example after a later multicast processing that transmits processed data units to several, e.g., all, output interfaces.

In further exemplary embodiments of the present invention, it is provided that the apparatus comprises an output modifier designed to at least temporarily modify at least one outgoing data unit and/or at least one descriptor associated with the at least one outgoing data unit.

In further exemplary embodiments of the present invention, it is provided that the input modifier and/or the output modifier is, for example, also arranged on the same semiconductor substrate as the other components of the apparatus.

In further exemplary embodiments of the present invention, it is provided that the apparatus is designed to allocate at least some data units to a flow, for example by means of a or the classifier device. In further exemplary embodiments, this, for example, enables processing of the data units on the basis of the respective flow or properties of the flow.

In further exemplary embodiments of the present invention, the input modifier and/or the output modifier can be controlled by at least one flow or on the basis of the at least one flow.

Further exemplary embodiments of the present invention relate to a method for processing data units by means of an apparatus, e.g., a hardware-based apparatus, wherein the apparatus comprises a first number of input interfaces for receiving data units and a second number of output interfaces for outputting data units, and a hardware-based processing device, which is designed to process data units of layers 2 and/or 3 and/or 4 and/or 5 and/or 6 of the ISO/OSI reference model, wherein the apparatus is, for example, designed according to the embodiments, wherein the method comprises: processing, e.g., at least temporarily processing, data units of layers 2 and/or 3 and/or 4 and/or 4 and/or 5 and/or 6 of the ISO/OSI reference model.

Further exemplary embodiments of the present invention relate to a use of the apparatus according to the embodiments and/or of the method according to embodiments for at least one of the following elements: a) processing, e.g., hardware-based processing, of data units of layers 2 and/or 3 and/or 4 and/or 5 of the ISO/OSI reference model, b) providing functions of a communication gateway, for example in the form of a monolithic hardware component, c) utilizing a statistical multiplexing gain by using a data storage device that can jointly be used by several components of the apparatus, d) classifying data units of different layers, e.g., of layers 2 and/or 3 and/or 4 and/or 5 and/or 6, of the ISO/OSI reference model, e) performing at least one function related to a service quality, e.g., Quality of Service, for data units of different layers, e.g., of layers 2 and/or 3 and/or 4 and/or 5 and/or 6, of the ISO/OSI reference model.

Further features, possible applications and advantages of the present invention emerge from the description below of exemplary embodiments of the present invention, which are illustrated in the figures. All described or depicted features by themselves or in any combination constitute the subject matter of the present invention, regardless of their formulation or representation in the description herein or in the figures.

### BRIEF DESCRIPTION OF THE DRAWINGS

FIG. 1 schematically shows a simplified block diagram according to exemplary embodiments of the present invention.

FIG. 2 schematically shows a simplified flow chart according to exemplary embodiments of the present invention.

FIG. 3 schematically shows a simplified block diagram according to exemplary embodiments of the present invention.

FIG. 4 schematically shows a simplified block diagram according to exemplary embodiments of the present invention.

FIG. 5 schematically shows a simplified block diagram according to exemplary embodiments of the present invention.

FIG. 6 schematically shows a simplified block diagram according to exemplary embodiments of the present invention.

FIG. 7 schematically shows a simplified block diagram according to exemplary embodiments of the present invention.

FIG. 8 schematically shows a simplified block diagram according to exemplary embodiments of the present invention.

FIG. 9 schematically shows a simplified block diagram according to exemplary embodiments of the present invention.

FIG. 10 schematically shows a simplified block diagram according to exemplary embodiments of the present invention.

FIG. 11 schematically shows aspects of uses according to exemplary embodiments of the present invention.

### DETAILED DESCRIPTION OF EXAMPLE EMBODIMENTS

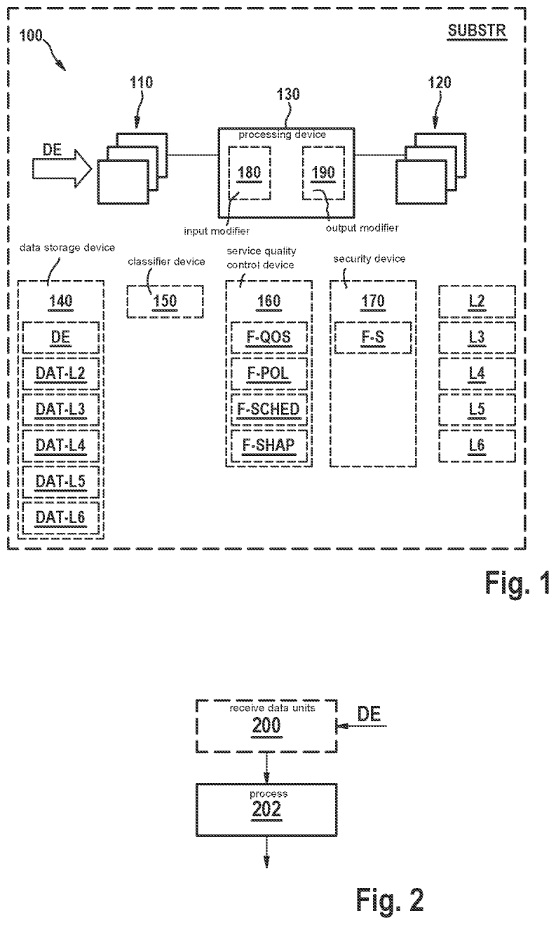

Exemplary embodiments of the present invention, FIG. 1, relate to an apparatus 100, e.g., a hardware-based apparatus 100, for processing data units DE, comprising a first number of input interfaces 110 for receiving data units and a second number of output interfaces 120 for outputting data units, and a hardware-based processing device 130, which is designed to process data units DE of at least one of the following layers of the ISO/OSI reference model: layer 2, layer 3, layer 4, layer 5, layer 6.

In further exemplary embodiments, the processing device 130 is designed to process data units of several different layers of the ISO/OSI reference model, for example one after the other and/or with an at least partial overlap in time.

In further exemplary embodiments, the data units DE may, for example, be data frames and/or protocol data units and/or data packets or the like.

In further exemplary embodiments, the first number of input interfaces 110 can be one or more input interfaces. In further exemplary embodiments, the second number of output interfaces 120 can be one or more output interfaces.

In further exemplary embodiments, it is provided that the apparatus 100 comprises a data storage device 140 for at least temporarily storing data DAT-L2, DAT-L3, DAT-L4, DAT-L5, DAT-L6 associated with data units DE of layers 2 and/or 3 and/or 4 and/or 5 and/or 6 of the ISO/OSI reference model (cf. blocks L2, L3, L4, L5, L6 according to FIG. 1), wherein the data storage device 140 can, for example, at least temporarily be jointly used by several components 110, 120, . . . of the apparatus 100. In further exemplary embodiments, this can at least temporarily result in statistical multiplexing gains.

In further exemplary embodiments, it is provided that the apparatus 100 comprises a classifier device 150 for classifying data units DE of layers 2, and/or 3 and/or 4 and/or 5 and/or 6 of the ISO/OSI reference model.

In further exemplary embodiments, it is provided that the apparatus 100 comprises a service quality control device 160 for performing at least one function F-QOS related to a service quality, e.g., Quality of Service, comprising, for example, at least one of the following elements: a) policing function F-POL, b) scheduling function F-SCHED, c) shaping function F-SHAP, wherein the service quality control device 160 is, for example, designed to perform functions F-QOS related to a service quality, e.g., Quality of Service, for data units DE of different layers, e.g., of layers 2 and/or 3 and/or 4 and/or 5 and/or 6, of the ISO/OSI reference model.

In further exemplary embodiments, it is provided that the apparatus 100 comprises a security device 170 for performing at least one function F-S related to a security, e.g., Security, wherein the security-related function F-S is, for example, associated with a, for example linked, access control list (e.g., chained access control list), wherein one and the same TCAM (ternary content addressable memory) instance can, for example, be used in different layers.

In further exemplary embodiments, several, e.g., two, TCAM instances can, for example, be provided, e.g., a first TCAM instance “L2_TCAM,” for example for data units of layer 2, and, for example, a second TCAM instance “L34_TCAM,” for example for data units of layers 3, 4 (and, optionally, for example, also for layer 5).

In further exemplary embodiments, the first TCAM instance “L2_TCAM” may, for example, provide three values “value1,” “value2,” “value3” on the basis of a key value “key,” for example according to: L2_TCAM: value1, value2, value3=f (key), wherein the key value “key,” for example, characterizes a target address, e.g., an Ethernet destination (e.g., MAC address), wherein the first value “value1,” for example, characterizes output interfaces (e.g., “ports”), for example in the form of a list to which the relevant data unit is to be transmitted, wherein the second value “value2,” e.g., “L2_TCAM_ID,” for example, indexes an entry of the first TCAM instance, which entry results in a match, and wherein the third value “value3,” for example, characterizes a connection identifier, e.g., “connection ID,” for example for identifying layer 2 (“L2”) streams (e.g., data streams), for example for per-stream filtering and/or per-stream policing, i.e., for example, for filtering and/or polishing on the basis of a respective data stream (“stream”), and/or for seamless redundancy.

In further exemplary embodiments, the second TCAM instance “L34_TCAM” may, for example, provide one or more values on the basis of a corresponding key value for the second TCAM instance. For example, in further exemplary embodiments, the key value for the second TCAM instance may comprise at least one of the following aspects: a) L1/2 port (interface, e.g., with respect to layer 1 (“L1”) and/or layer 2 (“L2”), b) L2 TCAM ID, obtained, for example, by the first TCAM instance (e.g., L2), C) IP (internet protocol) header (L3), d) UDP/TCP header (L4).

In further exemplary embodiments, by linking, for example, data of both TCAM instances, e.g., data of the second TCAM instance with data of the first TCAM instance, e.g., with the L2_TCAM_ID, a deep packet classification (“deep classification of a packet or a data unit”), e.g., via layers 1 (“L1”) to 4 (“L4”) can, for example, be performed, which classification, for example, provides as values: a) information about drop/pass (e.g., discarding or processing, for example of the relevant data unit), b) layer 4 (“L4”) IP socket identifiers, c) various, for example for special forwarding rules.

In further exemplary embodiments, a use of the TCAM component(s) or instance(s) in layer 5 (“L5”) is also possible. This is, for example, possible in further exemplary embodiments in that the TCAM instance(s) can also process data units that are not or not only associated with layers 2 to 4 (L2 . . . L4), but also data units associated with layers 5 and/or 6 (L5/6).

In further exemplary embodiments, it is provided that the apparatus 100 comprises an input modifier 180 designed to at least temporarily modify at least one incoming data unit and/or at least one descriptor associated with the at least one incoming data unit.

In further exemplary embodiments, it is provided that the apparatus 100 comprises an output modifier 190 designed to at least temporarily modify at least one outgoing data unit and/or at least one descriptor associated with the at least one outgoing data unit.

In further exemplary embodiments, it is provided that at least one component 110, 120, 130, 140, 150, 160, 170, 180, 190 of the apparatus 100 can be configured, e.g., configured at a runtime of the apparatus 100.

In further exemplary embodiments, it is provided that at least some, e.g., all, components 110, 120, 130, 140, 150, 160, 170, 180, 190 of the apparatus 100 are arranged on a, e.g., one and the same, semiconductor substrate SUBSTR.

In further exemplary embodiments, it is provided that the apparatus 100 is designed as a, for example monolithic, hardware component 100.

In further exemplary embodiments, it is provided that the apparatus 100 is designed to at least temporarily function as a communication gateway, for example in order to exchange data units or data frames or data packets between different input interfaces and/or output interfaces.

In further exemplary embodiments, it is provided that the apparatus 100 is designed to, at least temporarily, simultaneously process a) data units of layers 2 and/or 3 and/or 4 and/or 5 and/or 6 of the ISO/OSI reference model and/or b) of different protocols.

In further exemplary embodiments, it is provided that the apparatus 100 has a throughput of greater than 10 gigabits per second, Gbps, e.g., greater than 20 Gbps.

In further exemplary embodiments, it is provided that the apparatus 100 is designed to process data units at an event rate, e.g., Event Rate, of 10 million events per second, e.g., 10 Mevents/sec, e.g., at an event rate of up to 20 million events per second, e.g., 20 Mevents/sec.

Further exemplary embodiments, FIG. 2, relate to a method for processing data units DE by means of an apparatus 100, e.g., a hardware-based apparatus, wherein the apparatus 100 comprises a first number of input interfaces for receiving data units and a second number of output interfaces for outputting data units, and a hardware-based processing device, which is designed to process data units of at least one of layers 2 and/or 3 and/or 4 and/or 5 and/or 6 of the ISO/OSI reference model, wherein the apparatus 100 is, for example, designed according to the embodiments, wherein the method comprises: processing 202, e.g., at least temporarily processing, data units DE of layers 2 and/or 3 and/or 4 and/or 5 and/or 6 of the ISO/OSI reference model. In further exemplary embodiments, receiving of the data units DE (200) can, for example, take place prior to the processing 202.

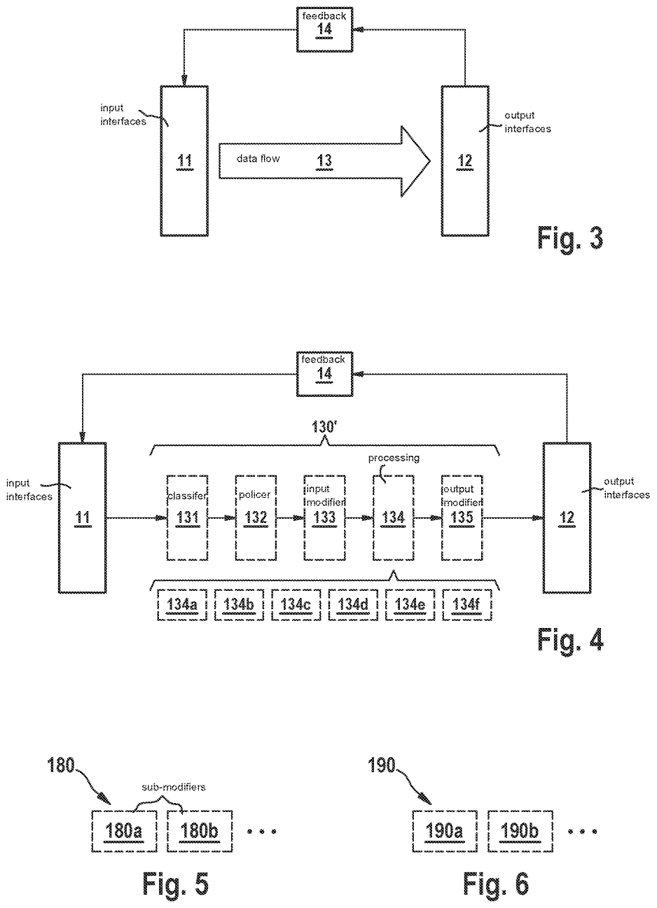

FIG. 3, by way of example, shows a schematic block diagram according to further exemplary embodiments. Block 11 symbolizes input interfaces 110 of the apparatus 100 (FIG. 1), block 12 symbolizes output interfaces 120 of the apparatus 100, block arrow 13 symbolizes a data flow and optionally processing of data units DE of data units that can be processed by means of the apparatus 100, e.g., by at least one component of the apparatus 100, and block 14 symbolizes optional feedback from the output interfaces 12 to the input interfaces 11.

FIG. 4, by way of example, shows a schematic block diagram according to further exemplary embodiments, wherein the bracket 130′ symbolizes an exemplary pipeline for processing data or data units by means of one or more components of the apparatus 100. Block 131 symbolizes an optional classifier, for example for classifying incoming data units of at least one of layers 2 and/or 3 and/or 4 and/or 5 and/or 6 of the ISO/OSI reference model, which can, for example, be implemented by means of the classifier device 150 (FIG. 1). Block 132 symbolizes an optional policer, for example for performing at least one function (F-QOS) related to a service quality, e.g., Quality of Service, e.g., a policing function (F-POL). Block 133 symbolizes an optional input modifier, see also FIG. 1, block 180. Block 134 symbolizes further optional processing blocks of the pipeline 130′, which, for example, comprise at least one of the following components: a) segment writer 134a, for example for writing or storing at least portions of data units DE, b) multicast device 134b, for example for distributing incoming data units to several receivers, c) an enqueue device 134c, for example for allocating at least portions of data units DE to at least one queue, d) a queue control device 134d, for example for controlling at least one queue, formed, for example, by means of a linked list, e) a dequeue device 134e, for example for eliminating at least portions of data units DE from the at least one queue, f) segment reader 134f, for example for reading or loading at least portions of, for example previously, stored data units DE, stored, for example, by means of the segment writer. Block 135 symbolizes an optional output modifier, see also FIG. 1, block 190.

In further exemplary embodiments, the input modifier 133, 180 is designed to receive a descriptor and associated data, for example of an incoming data unit DE, from the optional classifier 131 and the optional policer 132. In further exemplary embodiments, the input modifier 133, 180 is designed to modify the received descriptor and/or the received data, for example before the data are written to the data storage device 140, for example by means of the optional segment writer 134a.

As a result, in further exemplary embodiments, the modifications performed by means of the input modifier 133 become, for example, effective for some, e.g., all, possible output data streams, for example of the pipeline 130′, for example after their optional replication (according to further exemplary embodiments), for example by means of the optional multicast device 134b.

In further exemplary embodiments, the output modifier 135, 190 is designed to obtain a descriptor and associated data, for example from the optional segment reader 134f, for example after the data have been read from the data storage device 140. As a result, it is, for example, possible in further exemplary embodiments to modify a data unit several times, e.g., in respectively different ways.

In further exemplary embodiments, FIG. 5, the input modifier 180 (see also block 133 according to FIG. 4) comprises several, e.g., respectively different, sub-modifiers 180a, 180b, . . . , which, in further exemplary embodiments, can, for example selectively, be respectively applied to different types of data units.

In further exemplary embodiments, different data units can, for example, respectively be allocated to different flows FLW (“flows”or data flows) , for example by means of the classifier device 150, see also block 131 according to FIG. 4.

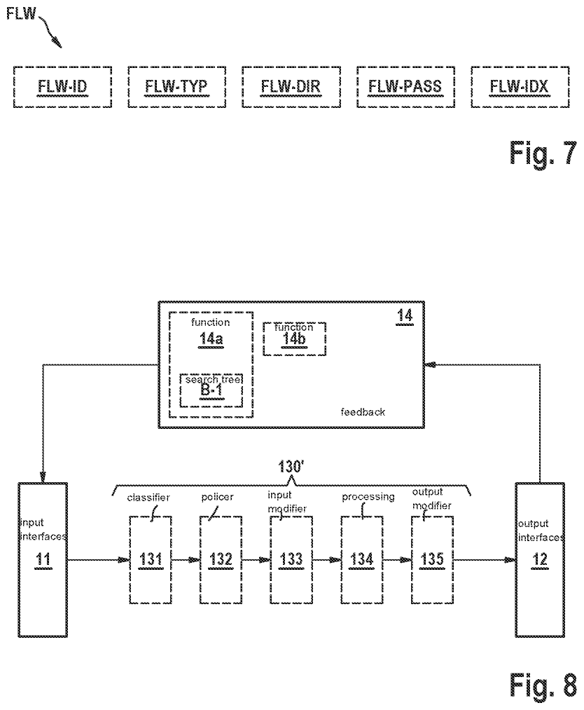

In further exemplary embodiments, FIG. 7, a flow FLW can be characterized or identified by means of a flow identifier, which, for example, represents a global identifier for the corresponding flow in the apparatus 100. In further exemplary embodiments, a flow can comprise at least one of the following properties: a) type FLW-TYP, b) direction FLW-DIR, c) pass FLW-PASS, d) instance and/or index FLW-IDX, wherein the properties, for example, of at least one data structure.

In further exemplary embodiments, flows FLW are used to describe data units or data traffic in the apparatus 100, for example to give data connections or several data units a meaning, for example with regard to a protocol and/or protocol layer (e.g., according to layer 2 and/or layer 3 and/or layer 4 and/or layer 5 and/or layer 6 according to ISO/OSI) and/or a direction.

In further exemplary embodiments, protocol-specific and/or protocol layer-specific modifications of data units can be performed by means of the apparatus on the basis of the flows FLW, e.g., of incoming data units, e.g., by means of the input modifier 180 (or corresponding sub-modifiers for a particular flow), and/or of outgoing data units, e.g., by means of the output modifier 190 (or corresponding sub-modifiers for a particular flow).

In further exemplary embodiments, channel identifiers can be generated on the basis of the flows FLW, for example in the region of the output interfaces 120.

In further exemplary embodiments, context-sensitive protocol handling, for example for XCPonEthernet, can, for example, be performed on the basis of the flows FLW.

In further exemplary embodiments, the different components 131, 132, . . . of the pipeline 130′ (FIG. 4) or the processing device 130 (FIG. 1) can process different data units, for example on the basis of the flow respectively allocated to them. This also, for example, enables the, possibly even at least partially simultaneous, processing of several data units that are, for example, associated with respectively different ISO/OSI layers. In further exemplary embodiments, a different flow can, for example, respectively be allocated to data units that are, for example, associated with respectively different ISO/OSI layers. In further exemplary embodiments, flows FLW can be generated or destroyed dynamically, i.e., for example, during operation of the apparatus 100.

In further exemplary embodiments, FIG. 8, the processing device 130 is designed to perform, on the basis of a data unit identifier associated with a received data unit, a search in at least a first search tree B-1, which, for example, comprises an allocation of in each case one data unit identifier to a connection identifier characterizing at least one data connection. A corresponding functionality may, for example, be provided in further exemplary embodiments in the feedback branch 14, see, for example, block 14a according to FIG. 8. For example, in further exemplary embodiments, the apparatus 100 is designed to ascertain, on the basis of the received data unit, a connection identifier associated with the received data unit, for example by means of the search in the first search tree B-1, which can, for example, be performed only in hardware. For example, in further exemplary embodiments, the processing device 130 may comprise at least one hardware component (not shown) designed to perform the search in the first search tree B-1 and/or to ascertain the connection identifier associated with the received data unit. For example, the first search tree B-1 is a binary tree. For example, the apparatus 100 is designed to output a received data unit to at least one particular output interface 120 on the basis of the connection identifier associated with the received data unit.

In further exemplary embodiments, block 14a can be used to, for example, convert interface-specific data units (e.g., of the CAN type or the Ethernet type or the LIN type, etc., e.g., L-PDUs) into non-interface-specific data units (e.g., RPDUs) and, optionally, to provide the non-interface-specific data unit(s) with metadata.

In further exemplary embodiments, in the feedback branch 14, at least one further function or a function block 14b may, for example, be provided, which processes at least some of the data unit(s) that can be processed by means of the apparatus 100 or the pipeline 130′, for example in the sense of feedback, for example in order to schedule a transport protocol.

In further exemplary embodiments, FIG. 8, the apparatus 100 or the pipeline 130′ can process data units DE of at least one of the following layers of the ISO/OSI reference model, e.g., several of the following layers, e.g., all of the following layers: layer 2 (L2), layer 3 (L3), layer 4 (L4), layer 5 (L5), layer 6 (L6). For this purpose, the relevant data units can, for example, respectively be allocated to a corresponding flow FLW (FIG. 7).

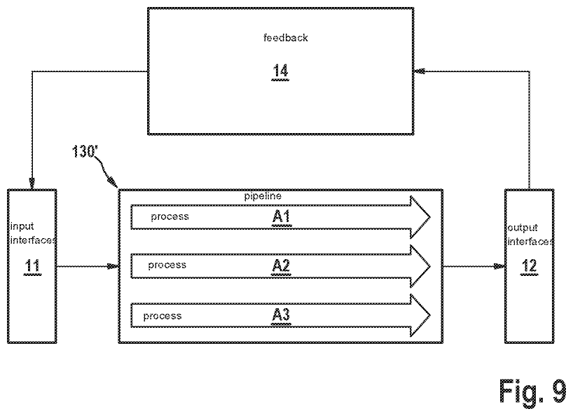

FIG. 9 schematically shows a block diagram according to further exemplary embodiments. Block arrows A1, A2, A3 symbolize processing of data units DE of different ISO/OSI layers using the pipeline 130′ already described, by way of example, above with reference to FIG. 8, wherein several “rounds” and passes of processing are, for example, performed by the pipeline 130′.

A first pass A1 may, for example, involve at least one of the following aspects:
scheduling data units of layer 2 L2 (FIG. 1),
Ethernet bridging L2 (Ethernet bridge, layer 2),
input-side buffering, e.g., input queuing, of data units of layer 2,
performing a MAC (medium access control) filtering and/or a multicast,
performing firewall functions, for example for data units of layers 2 to 4,
output-side buffering, e.g., output queuing L2, of data units of layer 2,
scheduling data units of layer 3, 4 L3/L4: e.g., IP, UDP, AVBTP,
scheduling data units of layer 2 L2: CAN, LIN.

A second pass A2 may, for example, involve at least one of the following aspects:
bridging and/or input-side buffering of, for example interface-specific, data units, e.g., L-PDUs,
input-side buffering of layer 2 data units, e.g., CAN, LIN, and/or layer 3/4 data units,
performing a filtering, e.g., of CAN or LIN data frames, and/or performing a multicast,
aggregation of data units,
output-side buffering, for example of data units of layer 5,
scheduling of layer 5 protocols, e.g., SomeIP, AUTOSAR PDU, AVBTP control messages,
identifying messages,
performing firewall functions,
performing functions related to a security, e.g., Security (e.g., in contrast to safety (functional safety)).

A third pass A3 may, for example, involve at least one of the following aspects:
input-side buffering of layer 5 data units

In further exemplary embodiments, one or more of the rounds described, by way of example, above with reference to FIG. 9, can be applied to incoming data units DE or portions thereof so that successive data of different ISO/OSI layers can, for example, be processed by means of the apparatus 100. In further exemplary embodiments, at least some of the data units or data derived therefrom can, for example, also be fed back from the output interfaces 12 to the input interfaces via the optional feedback 14.

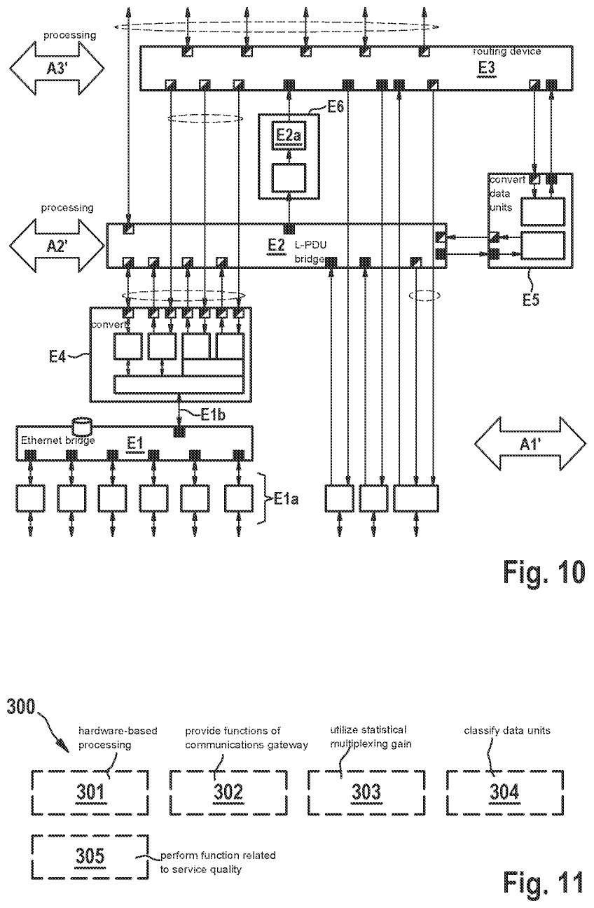

FIG. 10 shows a simplified block diagram according to further exemplary embodiments. By way of example, element E1 symbolizes an Ethernet bridge via which Ethernet data units can be exchanged. By way of example, element E2 symbolizes an optional L-PDU bridge via which data units of the L-PDU type can be exchanged, for example for aggregating. Optionally, the L-PDU bridge E2 may also carry out input buffering of L-PDUs. By way of example, element E3 symbolizes a routing device for data units.

By way of example, the function of the Ethernet bridge E1 and/or of the L-PDU bridge E2 and/or of the routing device E3 is realized at least temporarily by means of the pipeline 130′ (FIG. 9). In further exemplary embodiments, the Ethernet bridge E1 can, for example, receive Ethernet data units from the ports E1a and output them to the unit E4 via the port E1b. The unit E4 is, for example, designed to convert Ethernet (and/or UDP) data units (comprising, for example, contained PDUs) received from the unit E1 into L-PDUs and/or I-PDUs and to output them to the L-PDU bridge E2.

The optional unit E5 is designed to convert data units received from the unit E1, e.g., CAN data units or CAN data frames (comprising, for example, contained PDUs) into L-PDUs and/or I-PDUs and to output them to the L-PDU bridge E2.

The optional unit E6 is, for example, designed to perform the function of block 14a according to FIG. 8, i.e., for example, to perform, on the basis of a data unit identifier associated with a received data unit, a search in at least a first search tree B-1, which, for example, comprises an allocation of in each case one data unit identifier to a connection identifier characterizing at least one data connection. For example, the optional unit E6 may provide an ascertained connection identifier to the routing device E3, which, for example, performs routing on the basis of the connection identifier.

Optionally, the unit E6 may also, at least temporarily, perform firewall function(s) E6a with respect to data units processed by it.

Block arrow A1′ symbolizes, by way of example, processing of Ethernet data units by means of block E1, i.e., by the pipeline 130′ (FIG. 9) according to a first round.

Block arrow A2′ symbolizes, by way of example, processing of L-PDU and/or I-PDU data units by means of the L-PDU bridge E2, i.e., also by the pipeline 130′ (FIG. 9), but this time according to a second round.

Block arrow A3′ symbolizes, by way of example, processing, e.g., routing, of data units by means of the routing device E3, i.e., also by the pipeline 130′ (FIG. 9), but this time according to a third round.

The example described above with reference to FIG. 10 shows that data units that are associated with different layers of the ISO/OSI model, e.g., with layers 2 to 6, can efficiently be processed by means of the apparatus 100 or its pipeline 130′, i.e., for example, in a purely hardware-based manner. In particular, data units of layers 5 and/or 6 can, for example, also be processed by means of the apparatus 100, for example in a purely hardware-based manner.

By way of example, processing of data units associated with layers 3, 4 can take place by means of element E4 in further exemplary embodiments. By way of example, processing of data units associated with layer 5 can take place by means of element E6 in further exemplary embodiments.

Further exemplary embodiments, FIG. 11, relate to a use 300 of the apparatus 100 according to the embodiments and/or of the method according to embodiments for at least one of the following elements: a) processing 301, e.g., hardware-based processing, of data units DE of layers 2 and/or 3 and/or 4 and/or 5 and/or 6 of the ISO/OSI reference model, b) providing 302 functions of a communication gateway, for example in the form of a monolithic hardware component, c) utilizing 303 a statistical multiplexing gain by using a data storage device 140 that can jointly be used by several components of the apparatus, d) classifying 304 data units DE of different layers, e.g., of layers 2 and/or 3 and/or 4 and/or 5 and/or 6, of the ISO/OSI reference model, e) performing 305 at least one function related to a service quality, e.g., Quality of Service, for data units DE of different layers, e.g., of layers 2 and/or 3 and/or 4 and/or 5 and/or 6, of the ISO/OSI reference model.

In further exemplary embodiments, the apparatus 100 can dynamically distribute a processing bandwidth to the processing of different data units DE or data flows, e.g., flows FLW.

In further exemplary embodiments, the apparatus according to the embodiments can, for example, be used to realize a gateway, for example for the automobile sector, for example as an “automotive gateway ECU (electronic control unit, control unit).”

In further exemplary embodiments, the apparatus according to the embodiments can, for example, be used to realize an “automotive zone ECU,” i.e., a zone control unit, for example for the automobile sector.

In further exemplary embodiments, the apparatus according to the embodiments can, for example, be used to realize another control unit, for example for the automobile sector.

In further exemplary embodiments, the apparatus according to the embodiments can, for example, be used to realize a measuring device, for example for the automobile sector, for example for diagnostic purposes.

In further exemplary embodiments, the apparatus according to the embodiments can, for example, be used for a so-called virtualization, in which, for example by means of the apparatus, i.e., for example, in a hardware-based manner, classified data streams, for example in comparatively fine granularity, are, for example, supplied in a targeted manner to one of several optional computing devices (not shown), for example for further processing, for example in software. In further exemplary embodiments, the optional computing device can, for example, be regarded as a normal input and/or output interface, for example of the apparatus according to the embodiments. In this way, in further exemplary embodiments, particular data traffic, e.g., particular data streams or flows, which has or have, for example, been classified by means of the apparatus according to the embodiments, can, for example, be supplied in a targeted manner to the optional computing device, whereby disadvantages of some conventional systems can, for example, be reduced or avoided, in which the data are, for example, not classified in advance by means of hardware and are then supplied to a particular computing device in a targeted manner, but in which all the data are, for example, processed in software by means of a first computing device and some portions of all the data are, for example, provided to at least another computing device.

1-17. (canceled)

18. A hardware-based apparatus for processing data units, comprising:
a first number of input interfaces configured to receive data units;
a second number of output interfaces configured to output data units; and
a hardware-based processing device configured to process data units of at least a plurality of the following layers of an ISO/OSI reference model: layer 2, layer 3, layer 4, layer 5, layer 6.

19. The apparatus according to claim 18, further comprising:
a data storage device configured to at least temporarily storing data associated with data units of the layer 2 and/or the layer 3 and/or the layer 4 and/or the layer 5 and/or the layer 6 of the ISO/OSI reference model, wherein the data storage device can, at least temporarily, be jointly used by several components of the apparatus.

20. The apparatus according to claim 18, further comprising:
a classifier device configured to classify data units of the layer 2 and/or the layer 3 and/or the layer 4 and/or the layer 5 and/or the layer 6, of the ISO/OSI reference model.

21. The apparatus according to claim 18, further comprising:
a service quality control device configured to perform at least one function related to a service quality including, at least one of the following elements: a) policing function, b) scheduling function, c) shaping function, wherein the service quality control device is configured to perform the functions related to the service quality for data units of at least two different layers including the layer 2 and/or the layer 3 and/or the layer 4 and/or the layer 5 and/or the layer 6, of the ISO/OSI reference model.

22. The apparatus according to claim 18, further comprising:
a security device configured to perform at least one function related to a security.

23. The apparatus according to claim 18, wherein at least one component of the apparatus can be configured at a runtime of the apparatus.

24. The apparatus according to claim 18, wherein at least some components of the apparatus are arranged on one and the same semiconductor substrate.

25. The apparatus according to claim 18, wherein the apparatus is configured as a monolithic hardware component.

26. The apparatus according to claim 18, wherein the apparatus is configured to at least temporarily function as a communication gateway.

27. The apparatus according to claim 18, wherein the apparatus is configured to, at least temporarily, simultaneously process a) data units of the layer 2 and/or the layer 3 and/or the layer 4 and/or the layer 5 and/or the layer 6 of the ISO/OSI reference model, and/or b) data units of different protocols.

28. The apparatus according to claim 18, wherein the apparatus has a throughput of greater than 10 gigabits per second.

29. The apparatus according to claim 18, wherein the apparatus is configured to process data units at an event rate of at least 10 million events per second.

30. The apparatus according to claim 18, further comprising:
an input modifier configured to at least temporarily modify at least one incoming data unit and/or at least one descriptor associated with the at least one incoming data unit.

31. The apparatus according to claim 18, further comprising:
an output modifier configured to at least temporarily modify at least one outgoing data unit and/or at least one descriptor associated with the at least one outgoing data unit.

32. The apparatus according to claim 18, wherein the apparatus is configured to allocate at least some data units to a flow using a classifier device.

33. A method for processing data units using a hardware-based apparatus, wherein the apparatus includes a first number of input interfaces configured to receive data units, a second number of output interfaces configured to output data units, and a hardware-based processing device configured to process data units of at least one of the following layers of the ISO/OSI reference model: layer 2, layer 3, layer 4, layer 5, layer 6, wherein the apparatus, wherein the method comprises:
processing, at least temporary processing, data units of the layer 2 and/or the layer 3 and/or the layer 4 and/or the layer 5 and/or the layer 6, of the ISO/OSI reference model.

34. The apparatus according to claim 18, wherein the apparatus is used for at least one of the following elements: a) hardware-based processing, of data units of the layer and/or the layer 3 and/or the layer 4 and/or the layer 5 and/or the layer 6, of the ISO/OSI reference model, b) providing functions of a communication gateway as a monolithic hardware component, c) utilizing a statistical multiplexing gain by using a data storage device that can jointly be used by several components of the apparatus, d) classifying data units of at least two different layers of the layer 2 and/or the layer 3 and/or the layer 4 and/or the layer 5 and/or the layer 6, of the ISO/OSI reference model, e) performing at least one function related to a service quality for data units of at least two different layers of the layer 2 and/or the layer 3 and/or the layer 4 and/or the layer 5 and/or the layer 6, of the ISO/OSI reference model.
